(19) United States
(12) Patent Application Publication
(10) Pub. No.: US 2005/0168968 A1
(43) Pub. Date: Aug. 4, 2005

(54) Case for a backlight module (I)

(76) Inventors: Tang-Pung Lin, Tainan City (TW); Tzu-Chang Wang, Tainan County (TW)

Correspondence Address: OSTROLENK FABER GERB & SOFFEN, 1180 AVENUE OF THE AMERICAS, NEW YORK, NY, 100368403, US

(21) Appl. No.: 11/046,030

(22) Filed: Jan. 28, 2005

(30) Foreign Application Priority Data
Jan. 30, 2004 (TW) 093102169

(51) Int. Cl. G02F 1/13357; F21V 7/22

(52) U.S. Cl. 362/29; 362/296; 362/362; 349/67

(57) ABSTRACT

A case for a backlight module includes a housing body which receives a light source and has an opening directed toward a liquid crystal panel. A reflection layer is provided on a surface of the housing body to reflect the light emitted from the light source. The reflection layer has high weather-resistance and includes a resinous matrix material incorporating a UV/light stabilizer and a light-reflecting agent.

### CROSS-REFERENCE TO RELATED APPLICATION

This application claims priority from Taiwanese Patent Application No. 93102169 filed on Jan. 30, 2004.

### BACKGROUND OF THE INVENTION

1. Field of the Invention

This invention relates to a case, more particularly to a case of a backlight module.

2. Description of the Related Art

A liquid crystal display (LCD) device typically includes a drive circuit disposed in an LCD panel and actuated by a microprocessor (CPU) to display an image on the LCD panel. Since liquid crystals per se cannot emit light, for display of an image, a light source is needed in the LCD display device so as to irradiate light through the liquid crystals. The light source that emits light from a back side is called a backlight. Backlight devices are used to transform a point or line light source into a surface light source which is a high performance light source for LCD display devices. Commonly used backlight devices are of a direct bottom type and a side light type which are designed according to different positions of light sources.

Referring to FIGS. 1 and 2, there is shown an example of the direct bottom type backlight module which is disclosed in Japanese Patent Publication No. 2-109020. The backlight module 1 comprises a case 11 with a top opening, a diffusion plate 12 disposed horizontally at the top opening of the case 11, and a plurality of light sources 13 provided inside the case 11 below the diffusion plate 12. The case 11 includes a housing body 111 having a substantially U-shaped cross-section that is opened at a top side thereof. The housing body 111 has a horizontal base wall 113 and a surrounding wall 114 extending upward from the periphery of the base wall 113. The light sources 13 are provided on the base wall 113 and between two opposite sides of the surrounding wall 114. In use, the light emitted from the light sources 13 is irradiated upward to a liquid crystal display panel 14 through the diffusion plate 12. A portion of the emitted light incident on the case 11 is reflected from the case 11 to the diffusion plate 12 and is then projected upward so that an image is displayed on the LCD panel 14.

In order to display correct hues and colors on the LCD panel 14, the backlight module 1 must irradiate light rays with even hues and brightness through transparent regions of the LCD panel 14. For this purpose, the particular design of the case 11 which reflects light plays a significant role. Since the case 11 has to be highly reflective and has to reflect white light which does not synthesize color light, expensive polycarbonate (PC) which has high reflectivity is usually used as a material for fabricating the case 11. In addition, a white-colored material, such as titanium oxide, is blended with polycarbonate to produce the case 11 capable of reflecting white-colored light.

However, since the emitted light contains UV rays, although the case 11 can reflect white light, due to the case 11 made of polycarbonate which does not possess good weather-resistance, the case 11 is liable to degrade and turn yellow color when subjected to UV rays. The yellowed surface of the case 11 would reflect yellow light so that the LCD panel 14 will exhibit yellowish hue and colors, thereby resulting in poor color chromaticity in the LCD device.

Therefore, it is necessary to inspect the color difference between the color of the light reflected by the backlight case 11 and a white light after the backlight case 11 is illuminated for a period of long time. An equation for a standard color difference is as follows:
ΔE=√(ΔL²+Δa²+Δb²)
where L is luminance, and a and b represent colorities.

Generally, the standard color difference must be kept lower than “1.” A common test method for evaluating the color difference is conducted by using a backlight case having a size of 15 inches and by continuously illuminating the backlight case with the light of a cold cathode fluorescent lamp for 2000 hrs. When the backlight case 11 made of polycarbonate is tested through this method, the standard color difference (SE) is greater than 5 which does not meet the standard test level. Therefore, when the polycarbonate backlight case 11 is used, the life span of the backlight module would be relatively short, and a pure white light cannot be maintained.

Furthermore, since the above-described test method requires 2000 hours to obtain a test result, it is time-consuming. In order to speed up the test, there has been developed a quick test method in which the color difference is determined by illuminating a backlight case of 15 inches for 250 hrs with a UV wavelength of 313 nm and 1800 w (20 A/120 v) and at 70° C. and 90% humidity. When a polycarbonate backlight case is subjected to the quick test method, the resulting color difference (ΔE) is found to be higher than 10.

As manifested by the above-mentioned tests, the quality of the backlight case 11 is inferior and does not meet the standard test level. Therefore, how to prevent color degradation of the material of the backlight case 11 due to exposure to UV ray s is an important task so as to enable the backlight case 11 to reflect white light.

The case 11 further includes a layer of reflection sheet 112 adhered to the housing body 111 by means of a plurality of double-sided adhesive tapes 115 for the reflection of the light emitted from the light source 13 and for the prevention of color degradation of the housing body 111. However, it is necessary to first adhere the double-sided adhesive tapes 115 to the base wall 113 and then attach the reflection sheet 112 to the double-sided adhesive tapes 115 after the reflection sheet 112 is aligned with the base wall 113. Such a two-step adhering process to accomplish the three-layer arrangement requires careful attention of an operator during adjusting, aligning and sticking of the individual layers. Otherwise, the reflection sheet 112 will distort, forming wrinkles and blisters which result in products with defects and inferior quality. The laborious and time-consuming task for sticking the individual layers also increases the manufacturing cost.

Furthermore, although the acrylic base wall 113 of the case 11 of the direct bottom type backlight module 1 is covered by the reflection sheet 112, no protection is provided on the surrounding wall 114 of the case 11 so that the surrounding wall 14 can suffer from the problem of color degradation due to exposure to UV light. In addition, the reflection sheet 112 is liable to turn yellow after a period of time. Thus, the quality of the product still cannot be improved.

Referring to FIG. 3, there is shown a side light type backlight module 2 which includes a case 22 and a reflection sheet 222 adhered to the case 22. The case 22 also encounters the same problem of consuming much labor and time as the direct bottom type backlight module. So far as color degradation is concerned, since light sources 21 are provided oppositely in the case 22 at the sides of a light guide plate 24 and since reflection covers 23 are provided adjacent the sides of the case 22, the light emitted from the light sources 21 can be directed to the center and to the light guide plate 24 and is projected upward due to the reflection sheet 222 so that the LCD display panel 25 is illuminated to display images. Because of the shielding provided by the reflection covers 23, UV rays cannot easily reach the surrounding wall 221 of the side light type backlight module 2. However, the reflection sheet 222 tends to turn yellow after a period of time.

Referring to FIG. 4, there is shown a side light type backlight module 1′ which is disclosed in Taiwanese Patent Publication No. 1225560. The backlight module 1′ includes a case constituted of upper and lower frames 11′ and 15′ to receive diffusion members 12′ and a light guide plate 13′. A light source 16′ is provided at one side of the light guide plate 13′, and a reflection layer 14′ overlies the surface of the lower frame 15′. The reflection layer 14 is formed through a casting or coating process and is used to reflect light emitted from the light source 16′. While this publication teaches that the reflection layer 14′ may be coated directly onto the surface of the lower frame 15′, the reflection layer 14′ is aimed at providing only enhanced reflectivity to the backlight module 1′. The reflection layer 14′ will turn yellow after a period of time. The invention in this publication does not contemplate using the reflection layer 14′ to protect the lower frame 15′ from being attacked by UV rays.

### SUMMARY OF THE INVENTION

An object of the present invention is to provide a case of a backlight module with a reflection layer which is applied directly to the case, thereby facilitating the manufacturing of the case.

Another object of the present invention is to provide a case of a backlight module which is highly resistant to UV rays and color degradation.

According to the present invention, a case for a backlight module which includes a light source to illuminate a liquid crystal display panel, comprises: a housing body adapted to receive the light source and having an opening directed toward the liquid crystal display panel; and a reflection layer provided on a surface of the housing body and adapted to reflect the light emitted from the light source. The reflection layer has high weather-resistance and includes a resinous matrix material incorporating a UV/light stabilizer and a light-reflecting agent.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a sectional view of a conventional backlight module;

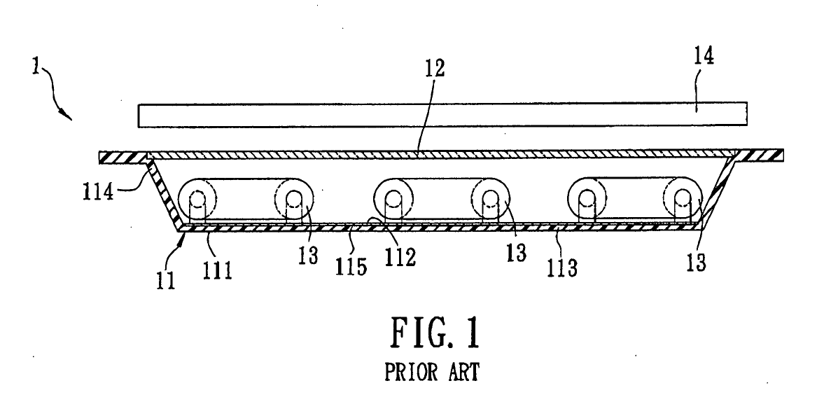

FIG. 2 is an exploded view of the backlight module of FIG. 1;

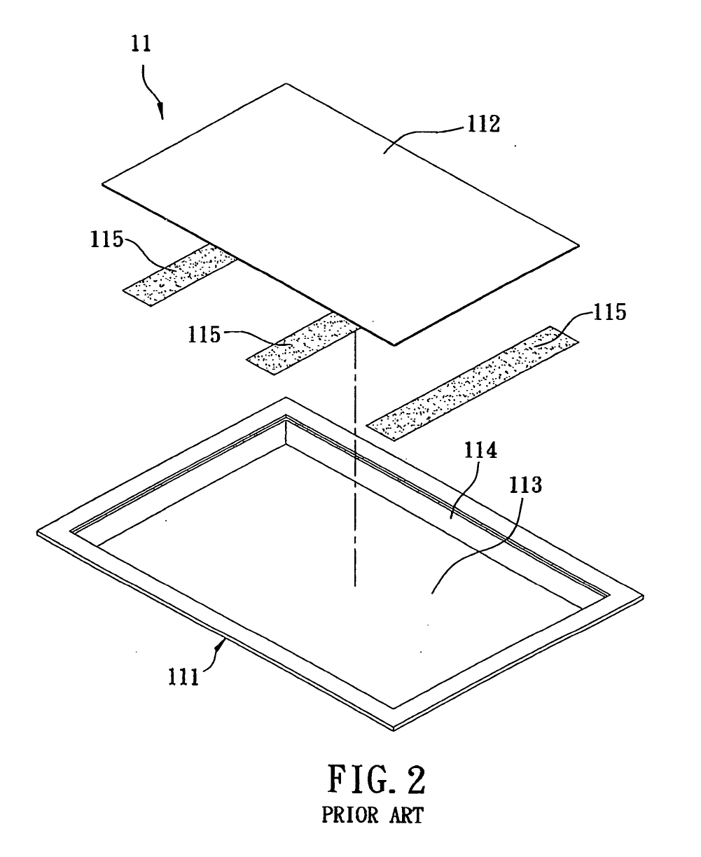

FIG. 3 is a sectional view of another conventional backlight module;

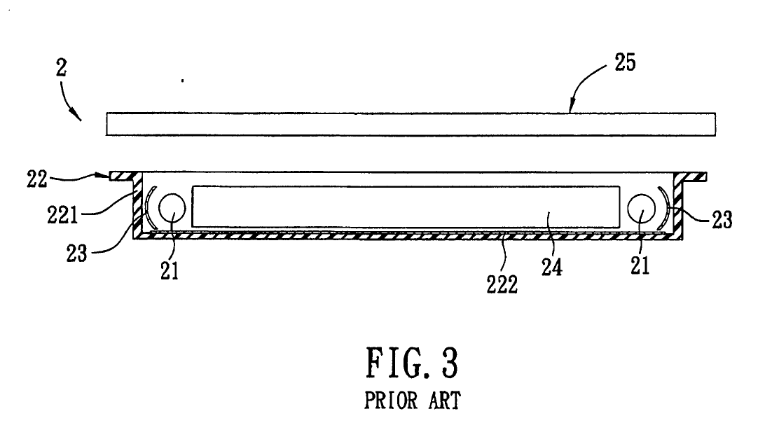

FIG. 4 is an exploded view of still another conventional backlight module;

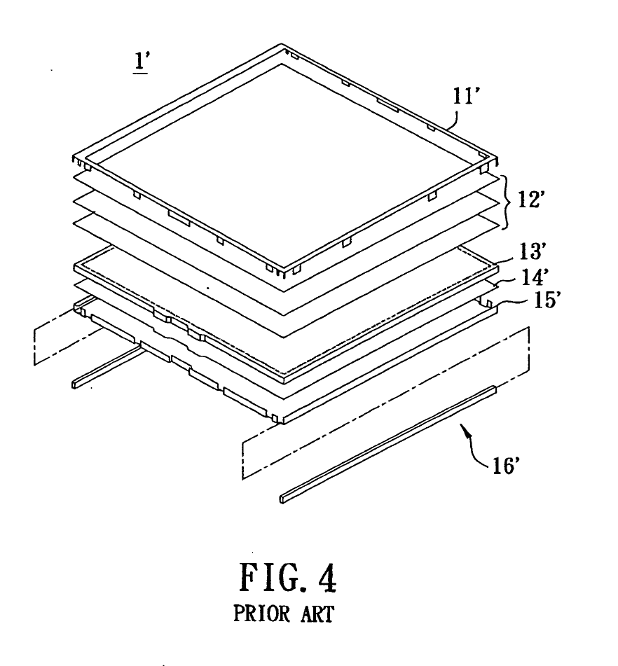

FIG. 5 is an exploded view of a first preferred embodiment of the present invention;

FIG. 6 is a sectional view of the first preferred embodiment of the present invention;

FIG. 7 is a fragmentary sectional view showing a portion of a case of the first preferred embodiment;

FIG. 8 is a perspective view of a second preferred embodiment of the present invention;

FIG. 9 is a fragmentary perspective view of the second preferred embodiment; and

FIG. 10 is a sectional view of a third preferred embodiment of the present invention.

### DETAILED DESCRIPTION OF THE PREFERRED EMBODIMENTS

Before the present invention is described in greater detail, it should be noted that same reference numerals have been used to denote like elements throughout the specification.

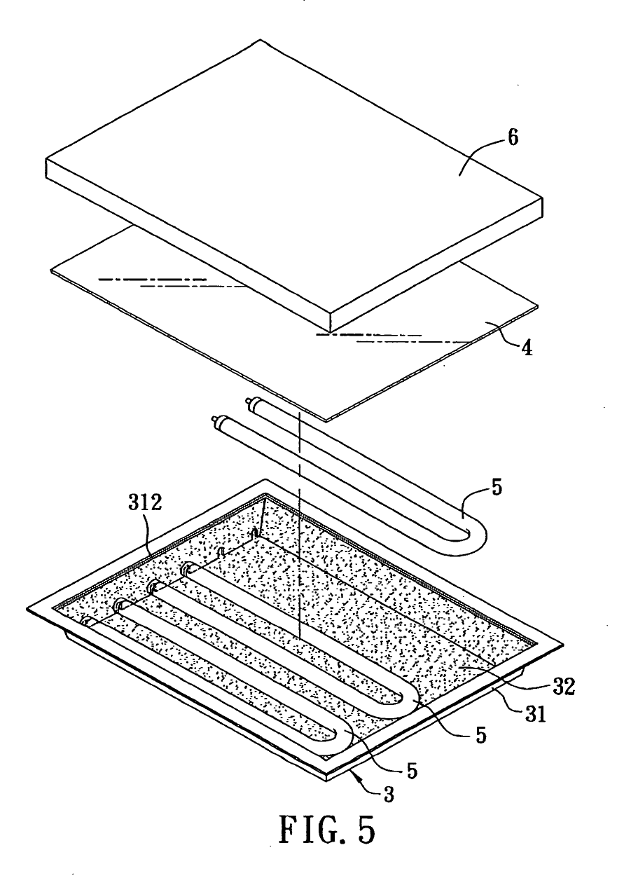

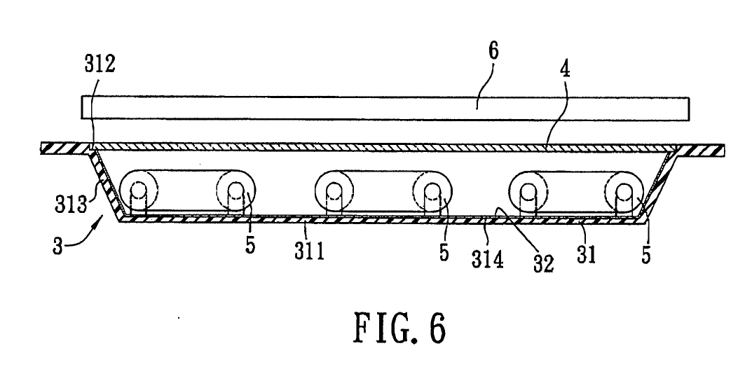

Referring to FIGS. 5 and 6, there is shown a first preferred embodiment of the present invention which includes a direct bottom type backlight module The backlight module of this embodiment includes a case 3, a diffusion plate 4 disposed on top of the case 3 and a plurality of spaced-apart light sources 5 disposed within the case 3 below the diffusion plate 4. Each light source 5 is a substantially U-shaped cold cathode fluorescent lamp. The light emitted from the light sources 5 is reflected from the case 3 to the diffusion plate 4, and the light from the diffusion plate 4 is dispersed toward a liquid crystal display panel 6. Of course, the quantity of the light source may be one cold cathode fluorescent lamp, or one surface light source, for instance, a planar CCFL, or a nanocarbon tube. The case 3 includes a housing body 31 and a reflection layer 32.

The housing body 31 has a substantially rectangular base wall 311 and a surrounding wall 313 extending from the base wall 33 to a top opening 312. The base and surrounding walls 311 and 313 define a surface 314. The diffusion plate 4 is disposed horizontally at the top opening 312. The light sources 5 are spaced apart on the base wall 311 and between two opposed sides of the surrounding wall 313.

The housing body 31 is made of a plastic material which is selected from the group consisting of fluorocarbon resins, silicone resins, acrylate resins, alkyd resins, styrenic resins, polyolefins, polycarbonates, nylon-based resins, polyester resins and any combination of the aforesaid resins. In other words, the plastic material may include a single resin, or a mixture of two or more resins selected from the aforesaid group.

The plastic material for the housing body 31 may further include a reinforcing agent which is selected from the group consisting of calcium carbonate, reinforcing fibers, titanium oxide, talc, mica, barium sulfate, zinc oxide, and any combination thereof.

The reflection layer 32 is provided on the surface 314 of the housing body 31 by spray coating, die extrusion coating or dip coating, and is formed of a resinous matrix material which has good weather-resistance and reflectivity and which incorporates a light-reflecting agent and a UV/light stabilizer.

The resinous matrix material may be selected from the group consisting of fluorocarbon resins, silicone resins, acrylate resins, alkyd resins, urea resins, epoxy resins, unsaturated polyesters, and a combination thereof.

The light-reflecting agent is selected from the group consisting of titanium oxide, zinc oxide, calcium carbonate, barium sulfate, talc and any combination thereof. Titanium oxide is the most preferred reflecting agent to be incorporated in the resinous matrix material.

The UV/light stabilizer is selected from the group consisting of amines, hindered amines, salicylates, benzotriazoles, benzophenones, nickel complexes and any combination thereof. The UV/light stabilizer may also serve as a light shading agent, a UV absorber, an excited quencher, or a free radical capturer, and has a UV absorbing property to absorb UV rays having a wavelength of less than 400 nm and an ability to decompose free radicals generated upon irradiation of UV rays so that the resinous matrix material is prevented from being attacked and degraded by the free radicals. Due to the UV/light stabilizer, a light stabilizing effect which prohibits or retards aging and degradation phenomena can be achieved.

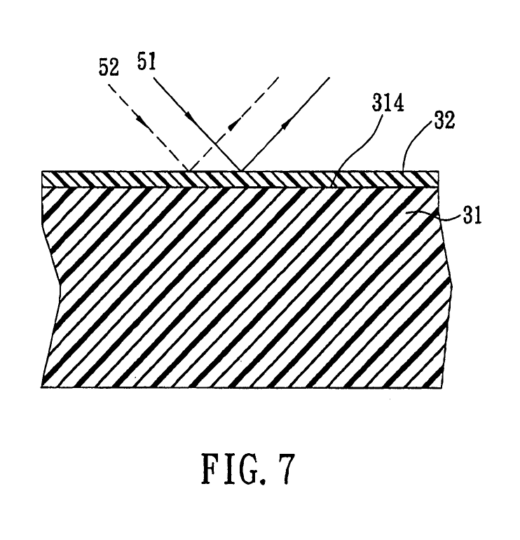

Referring to FIGS. 6 and 7, the light from the light sources 5 includes visible rays 51 and UV rays 52. In use, the light from the light sources 5 is irradiated directly upward and scattered outward from the diffusion plate 4. When a portion of the light is incident on the case 3, the UV and visible rays 52 and 51 are reflected from the reflection layer 32 to the top opening 312, and are dispersed and projected onto the liquid crystal display panel 6 by passing through the diffusion plate 4. As mentioned above, the reflection layer 32 completely covers the surface 314 of the housing body 31 and contains the UV/light stabilizer. Due to the protection afforded by the reflection layer 32 which possesses good weather-resistance and high reflectivity, the light can be efficiently reflected outward, and the case 3 will not be affected by the light and will not become yellowed.

When the quick test method is used to test the case 3 of the present invention, the color difference (ΔE) thereof is less than 0.5 and thus meets the industrial standard test level. Thus, the present invention provides good quality white reflection light.

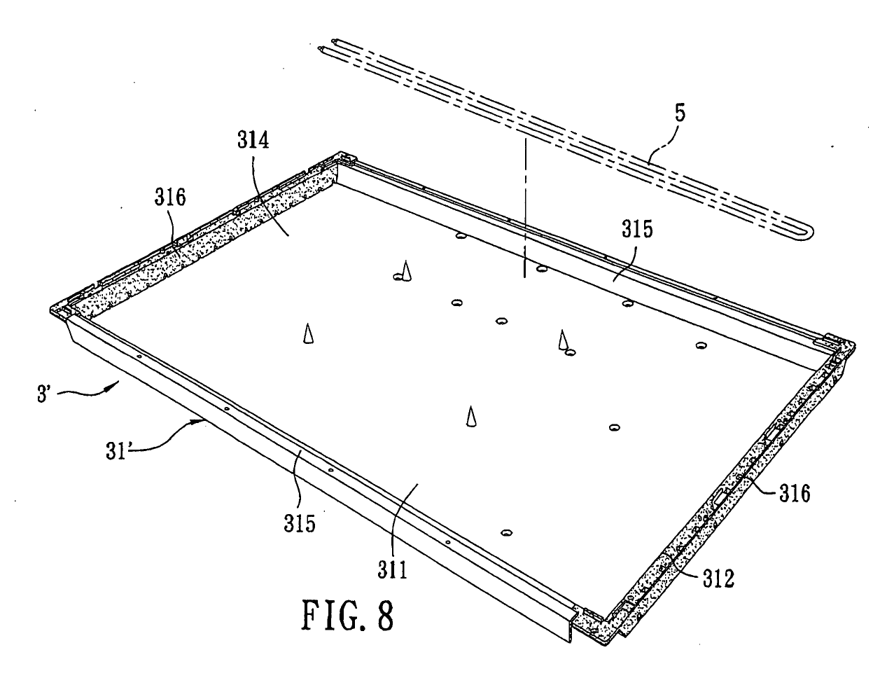

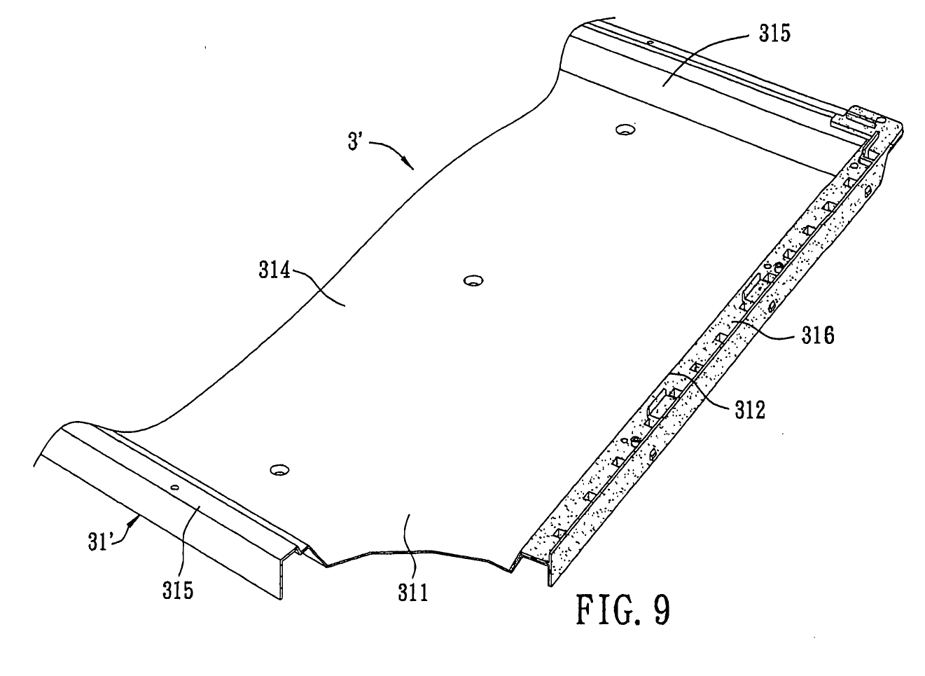

Referring to FIGS. 8 and 9, there is shown a second preferred embodiment of the backlight module according to the present invention which is substantially similar to the first preferred embodiment. However, this embodiment includes an enlarged rectangular case 3′. To hold stably the light sources 5, the housing body 31′ of the case 3′ has a base wall 311, an opposed pair of lateral walls 315 extending from two long sides of the base wall 311 to the top opening 312, and an opposed pair of connecting walls 316 extending from two short sides of the base wall 311 and interconnecting the lateral walls 315. The surface 314 is formed on the base wall 311, the lateral and connecting walls 315, 316 and is facing the top opening 312. The connecting walls 316 are made of a plastic material or a plastic material containing a reinforcing material. The light sources 5 are mounted between the connecting walls 316. The base and lateral walls 311, 315 are made of a metallic material. The metallic material is selected from the group consisting of galavanized steel, tinplate, aluminum alloys, magnesium alloys, stainless steel, and any combination thereof so that the large size structure can be stabilized.

Of course, there may be other options for the materials of the base, lateral and connecting walls 311, 315, 316. For example, all of the base, lateral and connecting walls 311, 315, 316 may be made of the metallic material. Alternatively, four of the base, lateral and connecting walls 311, 315, 316 may be made of the metallic material, and the other one may be made of the plastic material. Or, three of the base, lateral and connecting walls 311, 315, 316 may be made of the metallic material and the other two may be made of the plastic material. Or, two of the base, lateral and connecting walls 311, 315, 316 may be made of the metallic material and the other three may be made of the plastic material. Or, one of the base, lateral and connecting walls 311, 315, 316 may be made of the metallic material and the other four may be made of the plastic material.

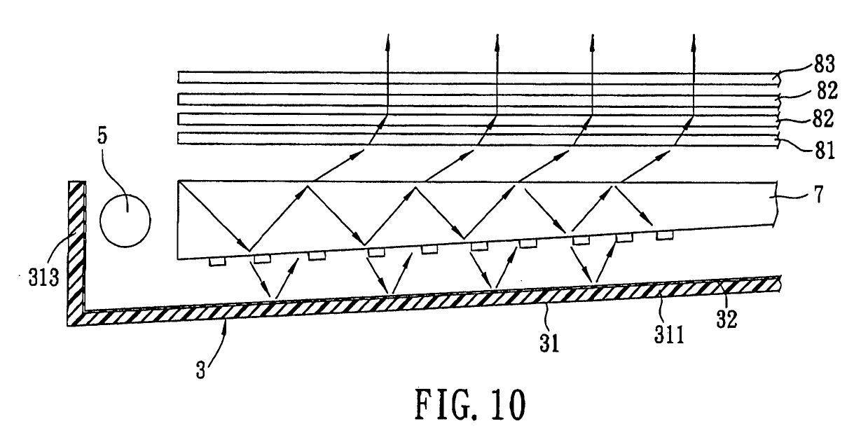

Referring to FIG. 10, there is shown a third preferred embodiment of the backlight module according to the present invention which differs from the first and second preferred embodiments in that the third embodiment is directed to a side light type backlight module. The side light type backlight module includes a case 3, two spaced apart light sources 5 disposed respectively at the sides of the base wall 311 proximate to the lateral walls 312, and a light guide plate 7 disposed between the light sources 5. Furthermore, a lower diffusion plate 81, two light enhancing plates 82 and an upper diffusion plate 83 are sequentially disposed above the light guide plate 7. Only one side is shown in FIG. 10. Of course, the light sources 5 may be disposed at one side or four sides of the case 3. In use, the light from the light sources 5 is irradiated from the side to the center and dispersed outward from the light guide plate 7. A portion of the light is incident on the case 3. The UV and visible rays of the light are reflected by the reflection layer 32 toward the light guide plate 7, the lower diffusion plate 81, the light enhancing plates 82 and the upper diffusion plate 83. The reflected light portion, together with the light rays directly irradiated to the light guide plate 7, is dispersed and projected onto the LCD panel (not shown).

The advantages of the present invention over the prior art are as follows:

1. Manufacturing is simple. In manufacturing, the reflection layer 32 is directly coated on the surface 314 of the case 31. Such is a directly interconnected two-layer construction which does not require layer-to-layer adhering steps. Such a construction facilitates the manufacturing process, does not entail the problem of wrinkle and blister formation, saves time and labor, reduces costs and provides good quality products.

2. Protection is efficient. Since the base wall 311 and the surrounding wall 313 of the housing body 31, 31′ are completely covered by the reflection layer 32 which is highly reflective, the light emitted from the light sources 5 disposed within the housing body 31, 31′ can be reflected upward to the LCD face panel 6 and can produce reflection light with white color. In addition, the UV rays 52 are unable to act on the housing body 31, 31′ so that the housing body 31, 31′ will not affect the color of the reflected light. According to the present invention, the housing body 31, 31′ is well protected so that it will not easily degrade and turn yellow. The life span of the backlight module is therefore prolonged. Regardless of whether the backlight module is of the direct bottom type or the side light type, the quality of reflection is superior. In manufacturing the case 3, 3′, an inexpensive material, such as ABS, PS, or PP, which is less resistant to yellowing, may be used for the reduction of the costs of materials.

From the aforesaid, it is evident that the case 3 of the backlight module provides the advantages, such as ease of production, less time and labor consumption, low costs, long life span, and excellent reflection characteristics. Therefore, The present invention is not only innovative but also contributes industrial utility.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A case for a backlight module which includes a light source to illuminate a liquid crystal display panel, comprising:
a housing body adapted to receive the light source and having an opening directed toward the liquid crystal display panel; and
a reflection layer provided on a surface of said housing body and adapted to reflect the light emitted from the light source, said reflection layer having high weather-resistance and including a resinous matrix material incorporating a UV/light stabilizer and a light-reflecting agent.

2. The case as claimed in claim 1, wherein said housing body further includes a base wall opposite to said opening, and a surrounding wall extending from said base wall to said opening, said surface being defined by said base wall and said surrounding wall and facing said opening.

3. The case as claimed in claim 1, wherein at least a part of said housing body is made of a plastic material which includes one or more resins selected from the group consisting of fluorocarbon resins, silicone resins, acrylate resins, alkyd resins, styrenic resins, polyolefins, polycarbonates, nylon-based resins and polyester resins.

4. The case as claimed in claim 3, wherein said plastic material further includes a reinforcing agent, said reinforcing agent including one or more substances selected from the group consisting of calcium carbonate, reinforcing fibers, titanium oxide, talc, mica, barium sulfate, and zinc oxide.

5. The case as claimed in claim 1, wherein at least a part of said housing body is made of a metallic material which includes one or more substances selected from the group consisting of galvanized steel, tin plate, aluminum alloys, magnesium alloys, and stainless steel.

6. The case as claimed in claim 2, wherein said surrounding wall includes an opposed pair of lateral walls extending from said base wall to said opening, and an opposed pair of connecting walls interconnecting said lateral walls.

7. The case as claimed in claim 6, wherein at least one of said base, lateral and connecting walls is made of a metallic material, the other ones of said base, lateral and connecting walls being made of a plastic material.

8. The case as claimed in claim 6, wherein at least one of said base, lateral and connecting walls is made of a plastic material, the other ones of said base, lateral and connecting walls being made of a metallic material.

9. The case as claimed in claim 1, wherein said resinous matrix material of said reflection layer includes one or more resins selected from the group consisting of fluorocarbon resins, silicone resins, acrylate resins, urea resins, epoxy resins, alkyd resins, and unsaturated polyesters.

10. The case as claimed in claim 1, wherein said UV/light stabilizer includes one or more substances selected from the group consisting of amines, hindered amines, salicylates, benzotriazoles, benzophenones, and nickel complexes.

11. The case as claimed in claim 1, wherein said light-reflecting agent includes one or more substances selected from the group consisting of titanium oxide, zinc oxide, calcium carbonate, barium sulfate, and talc.

12. The case as claimed in claim 1, wherein said reflection layer is formed on said surface of said housing body by spray coating.

13. The case as claimed in claim 1, wherein said reflection layer is formed on said surface of said housing body by die extrusion coating.

14. The case as claimed in claim 1, wherein said reflection layer is formed on said surface of said housing body by dip coating.

15. A method of manufacturing a case for a backlight module which includes a light source to illuminate a liquid crystal display panel, comprising:
a housing body adapted to receive the light source and having an opening directed toward the liquid crystal display panel; and
a reflection layer provided on a surface of said housing body and adapted to reflect the light emitted from the light source, said reflection layer having high weather-resistance and including a resinous matrix material incorporating a UV/light stabilizer and a light-reflecting agent;
wherein said reflection layer is formed on said surface of said housing body by spray coating.

16. A method of manufacturing a case for a backlight module which includes a light source to illuminate a liquid crystal display panel, comprising:
a housing body adapted to receive the light source and having an opening directed toward the liquid crystal display panel; and
a reflection layer provided on a surface of said housing body and adapted to reflect the light emitted from the light source, said reflection layer having high weather-resistance and including a resinous matrix material incorporating a UV/light stabilizer and a light-reflecting agent;
wherein said reflection layer is formed on said surface of said housing body by die extrusion coating.

17. A method of manufacturing a case for a backlight module which includes a light source to illuminate a liquid crystal display panel, comprising:
a housing body adapted to receive the light source and having an opening directed toward the liquid crystal display panel; and
a reflection layer provided on a surface of said housing body and adapted to reflect the light emitted from the light source, said reflection layer having high weather-resistance and including a resinous matrix material incorporating a UV/light stabilizer and a light-reflecting agent;
wherein said reflection layer is formed on said surface of said housing body by dip coating.
